(19) United States
(12) Patent Application Publication
(10) Pub. No.: US 2016/0048139 A1
(43) Pub. Date: Feb. 18, 2016

(54) Real-Time Chemical Process Monitoring, Assessment and Decision-Making Assistance Method

(71) Applicant: DOW GLOBAL TECHNOLOGIES LLC, Midland, MI (US)

(72) Inventors: Paul K. Samples, Scot Depot, WV (US); John R. Parrish, Charleston, WV (US)

(21) Appl. No.: 14/783,105

(22) PCT Filed: Mar. 4, 2014
(86) PCT No.: PCT/US14/20175

§ 371 Date: Oct. 8, 2015

Related U.S. Application Data
(60) Provisional application No. 61/815,839, filed on Apr. 25, 2013.

(51) Int. Cl. G05D 21/02; G06N 5/04; G05B 19/418

(52) U.S. Cl. CPC G05D 21/02; G05B 19/418; G06N 5/045; G05B 2219/31001; G05B 2219/32287

(57) ABSTRACT

A real-time method for operating plant executing a chemical process, comprising continuously, periodically or intermittently obtaining one or more process variable measurements; optionally, continuously, periodically or intermittently estimating one or more inferred process variables from measured process variables and/or mathematical models; estimating the current state of the chemical process based on the process variable measurements and/or inferred process variables; assessing the current state of the chemical process; projecting future probable process state based on the current state of the chemical process; linking the current and/or future probable process state with information in a database, the information comprising preferred actions aimed at favorably influencing the future process state; providing the information to a chemical process plant operating personnel; and optionally, performing manual and/or automatic actions aimed at favorably influencing the future process state of the chemical process is provided.

### FIELD OF INVENTION

The invention is a real-time chemical process monitoring, assessment and decision-making assistance method.

### BACKGROUND

Modern automation and information systems have provided many benefits in manufacturing and industrial facilities. In the context of chemical process plants, modern automation and information systems have allowed increased production rate, decreased off-grade resin, improved raw material efficiency and improved process reliability. However, such automation and information systems can also contribute to ‘information overload’ and subsequent confusion by the operating personnel as to the appropriate action or inaction. Such confusion on the part of the operating personnel frequently results in inappropriate actions. Inappropriate actions, in turn, can lead to manufacturing and industrial facility operating losses of millions of dollars annually.

A manufacturing and industrial facility monitoring, assessment and decision-making method to provide timely assessments of a manufacturing and industrial facility state and decision-making assistance which will alert operating personnel to current and probable future chemical process problem states and further provide real time directed advice regarding actions to correct and/or avoid such problem states would be beneficial.

### SUMMARY

The instant invention is a real-time chemical process monitoring, assessment and decision-making assistance method.

In one embodiment, the instant invention provides a real-time method for operating a chemical process plant, comprising continuously, periodically or intermittently obtaining one or more process variable measurements; optionally, continuously, periodically or intermittently estimating one or more inferred process variables from measured process variables and/or mathematical models; estimating the current state of the chemical process based on the process variables; assessing the current state of the chemical process; optionally, performing automatic process input adjustments; projecting future probable process state based on the current state of the chemical process; linking the current and/or future probable process state with information in a database, the information comprising preferred actions aimed at favorably influencing the future process state; providing the information to a chemical process plant operating personnel; optionally, monitoring the time between current state assessment and actions aimed at favorably influencing the future process state; and optionally, performing manual and/or automatic actions aimed at favorably influencing the future process state of the chemical process.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is a chart illustrating a first embodiment of the inventive method and the environment in which the method operates; and

FIG. 2 is a graph illustrating reactor bed temperature trend with 3 oscillation events, as discussed in Example 1.

### DETAILED DESCRIPTION

Embodiments of the instant invention is a real-time chemical process monitoring, assessment and decision-making assistance method.

The method according to the present invention comprises continuously, periodically or intermittently obtaining one or more process variable measurements; optionally, continuously, periodically or intermittently estimating one or more inferred process variables from measured process variables and/or mathematical models; estimating the current state of the chemical process based on the process variables; assessing the current state of the chemical process; optionally, performing automatic process input adjustments; projecting future probable process state based on the current state of the chemical process; linking the current and/or future probable process state with information in a database, the information comprising preferred actions aimed at favorably influencing the future process state; providing the information to a chemical process plant operating personnel; optionally, monitoring the time between current state assessment and actions aimed at favorably influencing the future process state; and optionally, performing manual and/or automatic actions aimed at favorably influencing the future process state of the chemical process.

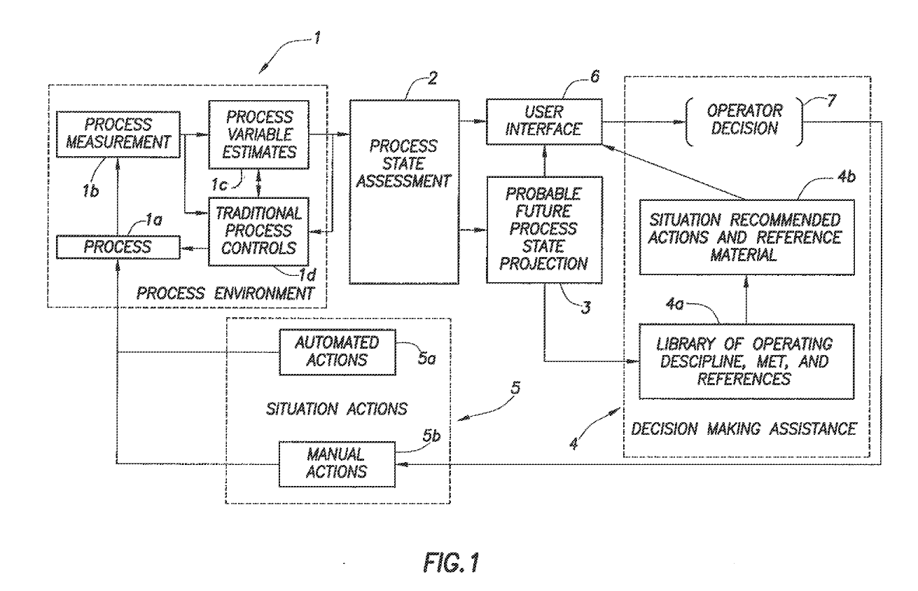

An overview of the method and the environment in which it operates is shown in FIG. 1. The Process Environment is shown in the dashed line area 1. The Process Environment includes the process plant, 1a, itself which comprises equipment directly part of the chemical process, including reactors, vessels, pumps, compressors, piping, valves, sensors and the like. Further included in the Process Environment are process measurements, 1b, which are made by various equipment and which is transmitted to a computer and/or control system and/or plant operating personnel. The process variables measured depend upon the particular chemical process but are generally well known to those of skill in the art. For example, reactor flow rates, pressures, and temperatures are commonly measured process variables. Traditional Process Controls, 1d, are known systems used to gather process measurements, display process information, take process control actions, and provide alarms. Such control systems are commonly known as Supervisory Control Systems, Distributed Control Systems, Programmable Logic Controllers and Safety Instrumented Systems. A final component of the Process Environment component include the Process Variable Estimates 1c. In certain instances, a direct measurement of a process variable cannot be obtained or cannot be obtained in a sufficiently timely fashion to allow the desired process control. In such instances, an estimate of the process variable may be calculated or estimated based upon other process conditions and/or process variables. Process variables which are calculated or estimated in this fashion are referred to herein as Inferred Variables. For example, in some gas phase olefin polymerization processes, no real-time, direct measurement of reactor resin production rate is available. However, the reactor resin production rate may be inferred from energy and material balance calculations.

The Process State Assessment is illustrated in the box 2. The Process State Assessment 2 reduces all available information and data into a clear view of the current process situation. Such assessment occurs by application of process models, calculations, product specific information, algorithms, and the like. Methods to assess the process state are known to those of ordinary skill in the art. For example, a process state may be based on predicted “measurements” derived using a dynamic process model solved on-line. The model may be corrected in a statistically optimal manner by real measurements which calibrate the dynamic process model. Such dynamic process models utilize equations which relate a product property with the process variables manipulated to control the product property. One such known method is described in “Model Prediction for Reactor Control,” CEP, 77-83, June 1983. Other known methods for assessing a process state are described in U.S. Pat. No. 8,032,328, the disclosure of which is incorporated herein by reference.

In certain instances, the process state may be relatively simply assessed by determining whether a certain process variable is within or outside of a desired range. For example, if the reactor resin production rate exceeds or is expected to exceed the available cooling system capacity in the near term, then an undesirable process situation exists.

Note that both timeliness and time itself may, in certain embodiments, impact proper process state assessment. That is, a process condition or process variable condition may require corrective action based on its initiation time or duration or the number of occurrences in a predetermined time frame. For example, consider a chemical process in which a deviation of the reactor bed temperature from the controller set point by 0.5° C. is not, by itself, an undesirable condition. One may surmise, however, that chemical processes may exist such that if that same deviation persists for greater than 1 hour during steady state conditions, then there is a much higher probability of production of an off-grade product.

The Probable Future Process State Projection element, illustrated by box 3, projects, or predicts, a probable future process state based on the current process state. The Probable Future Process State Projection can provide a basis for a diagnosis of and identification of the root cause of undesired process states. Projections are accomplished through rules associated with the situation and real-time data. For example, projections can be accomplished through use of one or more dynamic models and/or use of heuristics. The sophistication and use of dynamic models can range from use of a single, relatively simple mathematical model, such as a calculated variable rate of change, to multi-model ensembles such as that used in weather forecasting.

The Decision Making Assistance component, shown in dashed line box 4 in FIG. 1, ties plant operating personnel to the pertinent operating procedures based on the Process State Assessment and the Probable Future Process State Projection 3. The Decision Making Assistance component links the Process State Assessment and the Probable Future Process State Projection to the appropriate information library, 4a, in a database and identifies appropriate recommendations for actions aimed at favorably influencing the future process state as well as background reference material useful for review by process operating personnel, 4b. Such linking may be accomplished by any of a number of known methods or systems, including for example, heuristic methods and Karnaugh maps. In some embodiments, the linking may occur through on-line access to documentation related to the particular chemical process.

Once the Decision Making Assistance component identifies appropriate actions, the actions, shown by dashed line box 5 in FIG. 1, may be performed to move the process in a desired direction. These actions could be performed by automated systems, 5a, or by manual action by process operating personnel, 5b. For manual actions, the time between process state detection and resolution of the process state may be monitored. If resolution to the process state takes longer than a predetermined time, then an operator may be reminded to take action. The time measurement provides a feedback tool for system and operating personnel performance and may be used to identify opportunities for improvement.

For manual actions aimed at favorably influencing the future process state, the recommended actions are communicated to process operating personnel by way of the User Interface, illustrated as box 6 in FIG. 1, which is the primary mechanism by which operating personnel are alerted to problem situations and assisted through the decision-making process. The results of the Process State Assessment, 2, are also communicated to process operating personnel through the user interface 6. The user interface, box 6, may use any format to communicate the information to process operating personnel including, for example, graphical interfaces, process data trend illustrations, and text based documents. In some embodiments, the user interface may automatically transmit all or certain information by email or text or other communication methods to predetermined recipients. In alternative embodiments, the user interface may further cause all or certain information to be recorded, logged, or archived.

In an alternative embodiment, the instant invention provides a real-time chemical process monitoring, assessment and decision-making assistance method, in accordance with any of the embodiments disclosed herein, except that the method further alerting operating personnel to a probable undesirable future process state.

In an alternative embodiment, the instant invention provides a real-time chemical process monitoring, assessment and decision-making assistance method, in accordance with any of the embodiments disclosed herein, except that the one or more process variable measurements is selected from the group consisting of, but not limited to, reactor temperature(s), reactor pressure(s), static voltage throughout the reactor, reactor cycle gas analysis, inert reactor inflow rate, reactant reactor inflow rate, cycle gas reactor inflow rate, recovered materials reactor inflow rate, cycle gas reactor outflow rate, catalyst feed temperature(s), catalyst feed pressure(s) and catalyst feed flow rate, cycle cooling water system temperature(s), cycle cooling water system pressure(s), cycle cooling water system flow rate(s), product discharge system flow rate(s), product discharge system pressure(s), product discharge system temperature(s), timer values for product discharge system valves, product purge bin temperature(s), product purge bin pressure(s), product purge bin flow rates, product purge bin levels, product purge bin weights, extruder/pelletizer temperature(s), extruder/pelletizer flow rates, extruder/pelletizer speeds, extruder/pelletizer power level(s), and extruder/pelletizer pressures.

In an alternative embodiment, the instant invention provides a real-time chemical process monitoring, assessment and decision-making assistance method, in accordance with any of the embodiments disclosed herein, except that the one or more inferred process variables are selected from the group consisting of, but not limited to, compensated and corrected values of directly measured process variables, catalyst productivity, reactor production rate, reactor dewpoint, reactor cycle gas weight percent condensing, reactor fluidized bed weight, reactor resin fluidized bulk density, reactor bed level, reactor resin melt index, reactor resin melt flow index, reactor resin density, reactor resin melt flow ratio, reactor cycle gas molar ratio, reactor cycle gas partial pressures, reactor superficial gas velocities, reactor space time yield, mathematical and statistical calculations versions of direct reactor measurements, operating constraints, reactor ratio of hydrocarbon feed to produced resin, catalyst feed system mass flow rates, process fouling factors, product discharge system product drop discharge weight, product purge bin fluidized bed weight, product purge bin fluidized bed level, product purge bin resin mass outflow, product purge bin tracked resin position, product purge bin operating constraints, extruder/pelletizer tracked resin position, extruder/pelletizer operating constraints, and extruder/pelletizer pellet size.

In an alternative embodiment, the instant invention provides a real-time chemical process monitoring, assessment and decision-making assistance method, in accordance with any of the embodiments disclosed herein, except that the means of assessing the current state of the chemical process comprises process models, calculations, product specific information, algorithms, and combinations thereof.

In an alternative embodiment, the instant invention provides a real-time chemical process monitoring, assessment and decision-making assistance method, in accordance with any of the embodiments disclosed herein, except that the projection of the future probable process state comprises rules associated with the situation and real-time data.

In an alternative embodiment, the instant invention provides a real-time chemical process monitoring, assessment and decision-making assistance method, in accordance with any of the embodiments disclosed herein, except that the chemical process is a polymerization.

In an alternative embodiment, the instant invention provides a real-time chemical process monitoring, assessment and decision-making assistance method, in accordance with any of the embodiments disclosed herein, except that the chemical process is an olefin polymerization. Exemplary olefin polymerization processes include gas phase polyethylene and solution polyethylene processes.

In another alternative embodiment, the present invention provides a real-time method for operating an industrial and/or manufacturing plant executing an industrial and/or manufacturing process, comprising: continuously, periodically or intermittently obtaining one or more process variable measurements; optionally, continuously, periodically or intermittently estimating one or more inferred process variables from measured process variables and/or mathematical models; estimating the current state of the industrial and/or manufacturing process based on the process variable measurements and/or inferred process variables; assessing the current state of the industrial and/or manufacturing process; optionally, performing automatic process input adjustments; projecting future probable process state based on the current state of the industrial and/or manufacturing process; linking the current and/or future probable process state with information in a database, the information comprising preferred actions aimed at favorably influencing the future process state; providing the information to an industrial and/or manufacturing process plant operating personnel; optionally, monitoring the time between current state assessment and actions aimed at favorably influencing the future process state; and optionally, performing manual and/or automatic actions aimed at favorably influencing the future process state of the industrial and/or manufacturing process.

In an alternative embodiment, the instant invention provides a real-time method for operating plant executing a chemical process, consisting essentially of: continuously, periodically or intermittently obtaining one or more process variable measurements; optionally, continuously, periodically or intermittently estimating one or more inferred process variables from measured process variables and/or mathematical models; estimating the current state of the chemical process based on the process variable measurements and/or inferred process variables; assessing the current state of the chemical process; projecting future probable process state based on the current state of the chemical process; linking the current and/or future probable process state with information in a database, the information comprising preferred actions aimed at favorably influencing the future process state; and providing the information to a chemical process plant operating personnel.

In an alternative embodiment, the instant invention provides a real-time method for operating plant executing a chemical process, consisting essentially of: continuously, periodically or intermittently obtaining one or more process variable measurements; optionally, continuously, periodically or intermittently estimating one or more inferred process variables from measured process variables and/or mathematical models; estimating the current state of the chemical process based on the process variable measurements and/or inferred process variables; assessing the current state of the chemical process; projecting future probable process state based on the current state of the chemical process; linking the current and/or future probable process state with information in a database, the information comprising preferred actions aimed at favorably influencing the future process state; providing the information to a chemical process plant operating personnel; performing automatic process input adjustments; monitoring the time between current state assessment and actions aimed at favorably influencing the future process state; and performing manual and/or automatic actions aimed at favorably influencing the future process state of the chemical process.

In an alternative embodiment, the instant invention provides a real-time method for operating plant executing a chemical process, consisting essentially of: continuously, periodically or intermittently obtaining one or more process variable measurements; optionally, continuously, periodically or intermittently estimating one or more inferred process variables from measured process variables and/or mathematical models; estimating the current state of the chemical process based on the process variable measurements and/or inferred process variables; assessing the current state of the chemical process; projecting future probable process state based on the current state of the chemical process; linking the current and/or future probable process state with information in a database, the information comprising preferred actions aimed at favorably influencing the future process state; providing the information to a chemical process plant operating personnel; and alerting operating personnel to a probable undesirable future process state.

In an alternative embodiment, the instant invention provides a real-time method for operating plant executing a chemical process, consisting essentially of: continuously, periodically or intermittently obtaining one or more process variable measurements; optionally, continuously, periodically or intermittently estimating one or more inferred process variables from measured process variables and/or mathematical models; estimating the current state of the chemical process based on the process variable measurements and/or inferred process variables; assessing the current state of the chemical process; projecting future probable process state based on the current state of the chemical process; linking the current and/or future probable process state with information in a database, the information comprising preferred actions aimed at favorably influencing the future process state; providing the information to a chemical process plant operating personnel; and providing the operating personnel with targeted information and documentation related to actions favorably influencing the future process state of the chemical process.

### EXAMPLES

The following examples illustrate the present invention but are not intended to limit the scope of the invention.

### Example 1

This example was conducted using hypothetical process variables. A polymerization process is carried out in a gas phase fluidized bed reactor using a Ziegler-Natta catalyst. The reactor is operated continuously within the following ranges: a) total reactor pressure from about 19 to about 21.5 bar (about 280 to about 310 psig); b) reactor bed temperature from about 80.0 to about 90.0° C. The α-olefins fed into the reactor are ethylene and 1-butene. The feed gas composition, by weight, is from about 37 to about 42 percent ethylene; from about 8.0 to about 12.00 percent 1-butene; from about 7.0 to about 10.0 percent hydrogen; and the balance includes nitrogen, ethane, methane, and 1-butane.

The reactor bed temperature (RBT) is measured by a resistance temperature detector (RTD) at approximately 30 centimeters above the distributor plate and is inserted approximately 20 centimeters. The reactor bed temperature is controlled to a desired set point by a traditional process controller. In addition, the current reactor bed temperature value, along with other process variables values, is sent to a process computer system to create a current process state estimation.

The process variables are communicated to the process computer system every 5 to 60 seconds. The data communication speed is chosen to appropriately capture relevant process dynamics so that timely assessments and actions are performed. The reactor is determined to be in a normal operating state by predetermined criteria. In this example the normal operating state criteria is a reactor recycle gas flow greater than about 91,000 kg/hr, a reactor bed temperature greater than about 50° Celsius, a ethylene reactor gas composition by weight greater than about 8 percent, a difference between reactor inlet temperature and reactor outlet temperature is greater than about 5° Celsius and the reactor is making a single resin polymer type.

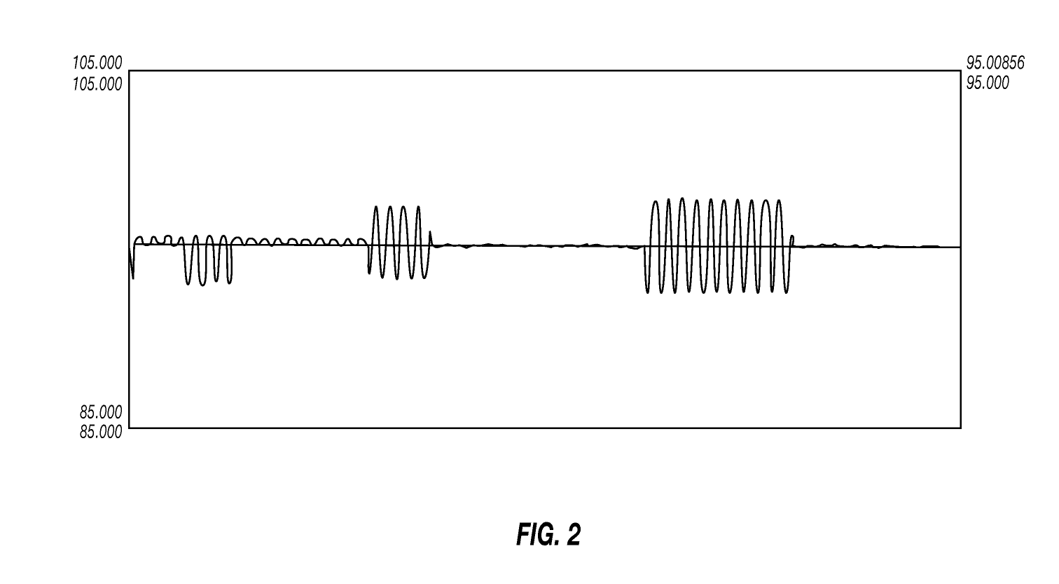

An assessment is then performed on reactor temperature control information. A pattern recognition technique is employed where a deadband of 0.65° Celsius and first order response time of 2 minutes are parameters used to detect various behavior, such a control variable sluggish responsiveness or oscillations. The parameters were chosen based on analysis of typical acceptable variation of the reactor bed temperature. FIG. 2 shows a trend of the reactor bed temperature and the reactor bed temperature set point over a six hour period. There are three separate oscillation detections that are assessed to be undesirable behavior based on the parameters mentioned above. In each case, a message is logged in a computer file for historical purposes, the three messages shown below:

May 24, 2012—Time 13-09-46—Reactor Bed Temperature Oscillatory PV

May 24, 2012—Time 14-19-12—Reactor Bed Temperature Oscillatory PV

May 24, 2012—Time 15-51-37—Reactor Bed Temperature Oscillatory PV

In this example, when two reactor bed temperature oscillation detections occur within a two hour period then it is probable that in the future undesirable process performance, such as out of specification polymer or lower production rates, will occur. At this point an indicator is shown to the plant operating and support personnel in messages, on graphic displays, and in email. The indicator is linked to information that provides specific guidance. The information includes pre-configured trends (similar to FIG. 2), on-line operating procedures, and on-line web based information and links. The plant operating personnel, based on the on-line operating procedures, contact process control support personnel to evaluate the reactor bed temperature controller. Modifications to the reactor bed temperature controller tuning parameters are manually made to improve performance.

The present invention may be embodied in other forms without departing from the spirit and the essential attributes thereof, and, accordingly, reference should be made to the appended claims, rather than to the foregoing specification, as indicating the scope of the invention.

We claim:

1. A real-time method for operating plant executing a chemical process, comprising:
continuously, periodically or intermittently obtaining one or more process variable measurements;
optionally, continuously, periodically or intermittently estimating one or more inferred process variables from measured process variables and/or mathematical models;
estimating the current state of the chemical process based on the process variable measurements and/or inferred process variables;
assessing the current state of the chemical process;
optionally, performing automatic process input adjustments;
projecting future probable process state based on the current state of the chemical process;
linking the current and/or future probable process state with information in a database, the information comprising preferred actions aimed at favorably influencing the future process state;
providing the information to a chemical process plant operating personnel;
optionally, monitoring the time between current state assessment and actions aimed at favorably influencing the future process state; and
optionally, performing manual and/or automatic actions aimed at favorably influencing the future process state of the chemical process.

2. The real-time method for operating a chemical process plant according to claim 1, further comprising alerting operating personnel to a probable undesirable future process state.

3. The real-time method for operating a chemical process plant according to claim 1, further comprising providing the operating personnel with targeted information and documentation related to actions favorably influencing the future process state of the chemical process.

4. The real-time method for operating a chemical process plant according to claim 1, wherein the one or more inferred process variables are selected from the group consisting of compensated and corrected values of directly measured process variables, catalyst productivity, reactor production rate, reactor dewpoint, reactor cycle gas weight percent condensing, reactor fluidized bed weight, reactor resin fluidized bulk density, reactor bed level, reactor resin melt index, reactor resin melt flow index, reactor resin density, reactor resin melt flow ratio, reactor cycle gas molar ratio, reactor cycle gas partial pressures, reactor superficial gas velocities, reactor space time yield, mathematical and statistical calculations versions of direct reactor measurements, operating constraints, reactor ratio of hydrocarbon feed to produced resin, catalyst feed system mass flow rates, process fouling factors, product discharge system product drop discharge weight, product purge bin fluidized bed weight, product purge bin fluidized bed level, product purge bin resin mass outflow, product purge bin tracked resin position, product purge bin operating constraints, extruder/pelletizer tracked resin position, extruder/pelletizer operating constraints, and extruder/pelletizer pellet size.

5. The real-time method for operating a chemical process plant according to claim 1, wherein the one or more process variable measurements are selected from the group consisting of reactor temperature(s), reactor pressure(s), static voltage throughout the reactor, reactor cycle gas analysis, inert reactor inflow rate, reactant reactor inflow rate, cycle gas reactor inflow rate, recovered materials reactor inflow rate, cycle gas reactor outflow rate, catalyst feed temperature(s), catalyst feed pressure(s) and catalyst feed flow rate, cycle cooling water system temperature(s), cycle cooling water system pressure(s), cycle cooling water system flow rate(s), product discharge system flow rate(s), product discharge system pressure(s), product discharge system temperature(s), timer values for product discharge system valves, product purge bin temperature(s), product purge bin pressure(s), product purge bin flow rates, product purge bin levels, product purge bin weights, extruder/pelletizer temperature(s), extruder/pelletizer flow rates, extruder/pelletizer speeds, extruder/pelletizer power level(s), and extruder/pelletizer pressures.

6. The real-time method for operating a chemical process plant according to claim 1, wherein the chemical process is a polymerization.

7. The real-time method for operating a chemical process plant according to claim 1, wherein the chemical process is an olefin polymerization.
